(19) United States
(12) Patent Application Publication
(10) Pub. No.: US 2026/0127511 A1
(43) Pub. Date: May 7, 2026

(54) CARGO TERMINAL MANAGEMENT SYSTEM

(71) Applicant: ALLY LOGISTIC PROPERTY CO., LTD., Taipei City (TW)

(72) Inventor: CHIEN-TAI CHANG, Taipei City (TW)

(21) Appl. No.: 19/183,989

(22) Filed: Apr. 21, 2025

(30) Foreign Application Priority Data
Nov. 1, 2024 (TW) 113141944

(51) Int. Cl. G06Q 10/02; G06Q 10/083

(52) U.S. Cl. CPC G06Q 10/02; G06Q 10/083

(57) ABSTRACT

A cargo terminal management system includes a carrier module, a management module, and an onsite module. The carrier module provides access to registration of a reservation information, and generates a reservation certificate based on the reservation information. The management module is coupled with the carrier module and has a management information displayed on a terminal device corresponding to the reservation information. The onsite module is coupled with the carrier module and the management module. When the reservation certificate is input into the onsite module, it generates a check-in information displayed on the terminal device and transmitted to the management module. The present disclosure enables logistics companies to efficiently arrange the cargo loading and unloading process, improving operational efficiency and safety, and reducing error rates.

### BACKGROUND OF THE DISCLOSURE

### 1. Field of the Disclosure

The present disclosure relates to management systems, and more particularly, to a cargo terminal management system.

### 2. Description of the Related Art

As international economic cooperation becomes increasingly intense, consumption, manufacturing, and transportation operations have gradually transcended national borders, forming an economic “global village.” In turn, logistics transportation volume has grown significantly, and logistics companies require a system for efficiently arranging cargo handling process.

The conventional cargo transportation practice is carried out as follows.

Freight forwarders submit reservation requests to the cargo terminal managers via phone, fax, or email, and the managers respond in the same manner. Alternatively, freight forwarders confirm the availability of warehouse with the managers using the aforementioned communication methods, and the managers accordingly reply.

When drivers of logistics companies transport goods to the dock, they have to personally reach the cargo terminal office to register their information and confirm information including their identity, vehicle, and cargo quantities with the office security, so as to complete the check-in process.

Dispatchers have to constantly verify the availability of the warehouse with the warehouse staff before allowing trucks to proceed to the warehouse.

Accordingly, it is clear that such approach is not only time-consuming and labor-intensive, but also fails to accurately track the warehouse availability, affecting the overall loading and unloading efficiency.

### SUMMARY OF THE DISCLOSURE

The present disclosure aims at providing a cargo terminal management system, which enables logistics companies to effectively arrange the cargo handling process.

The aforementioned objective does not preclude the existence of other objectives. Any objectives derivable from the specification, claims, or drawings, based on the common knowledge of those skilled in the field of the disclosure are also included within the scope of the objectives of the present disclosure.

For achieving the aforementioned objectives, the present disclosure provides a cargo terminal management system disposed on a server coupled with a terminal device, which runs the cargo terminal management system, the cargo terminal management system comprising:
a carrier module providing access to registration of a reservation information, the carrier module configured to generate a reservation certificate based on the reservation information;
a management module coupled with the carrier module, the management module having a management information corresponding to the reservation information, the management information being displayed on the terminal device; and
an onsite module coupled with the carrier module and the management module; when the reservation certificate is input into the onsite module, the onsite module generates a check-in information displayed on the terminal device, and the onsite module transmits the check-in information to the management module.

With such configuration, the present disclosure achieves following advantages.

The operational efficiency is improved. The present disclosure applies various modules for reservation operations, not only simplifying the reservation process, but also achieving an efficient resources allocation, such as docks, personnel, and equipment, thereby enhancing operational efficiency and reducing workload of staff. Also, during the check-in process, the present disclosure reduces the waiting time of the driver, preventing congestion of trucks and further improving the overall operational efficiency.

Error rate is lowered. With a timely management, the present disclosure efficiently allows a quick understanding of docks'reservation status, vacant areas, and operation progress, thereby preventing information gaps between different units and reducing occurrence of errors.

Operational safety is improved. The present disclosure helps reduce the movement of personnel at the dock required for the purposes of, for example, confirming the drivers'identity, verifying conditions of docks, and confirming the warehouse entering and exiting conditions of trucks, so as to achieve a safer working environment and further protect the safety of employees.

### BRIEF DESCRIPTION OF THE DRAWINGS

FIG. 1 is a block view of the cargo terminal management system in accordance with an embodiment of the present disclosure, illustrating the relationship between each element.

FIG. 2 is a schematic view of the operation of the management module, illustrating the management information in accordance with an embodiment of the present disclosure.

FIG. 3 is a schematic view of the operation of the onsite module, illustrating the check-in information in accordance with an embodiment of the present disclosure.

FIG. 4 is a schematic view of the operation of the smart monitoring module, illustrating the warehouse image information in accordance with an embodiment of the present disclosure.

FIG. 5 is another schematic view of the operation of the onsite module, illustrating the operation progress information in accordance with an embodiment of the present disclosure.

### DETAILED DESCRIPTION OF THE DISCLOSURE

The aforementioned and further advantages and features of the present disclosure will be understood by reference to the description of the preferred embodiment in conjunction with the accompanying drawings where the components are illustrated based on a proportion for explanation but not subject to the actual component proportion.

Embodiments of the present disclosure are illustrated in detail along with the drawings. However, the technical features included by the present disclosure are not limited to certain embodiments hereby provided. Scope of the present disclosure shall be referred to the claims, which include all the possible replacements, modifications, and equivalent features.

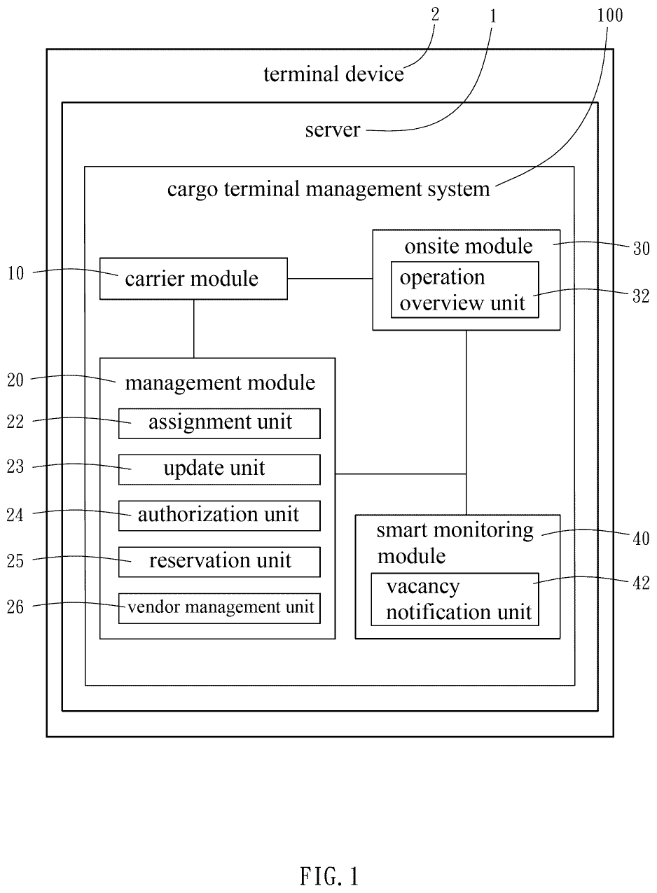

Referring to FIG. 1 to FIG. 5, an embodiment of the present disclosure provides a cargo terminal management system 100, which is disposed on a server 1.

Referring to FIG. 1, the server 1 is coupled with a terminal device 2. The terminal device 2 is configured to run the cargo terminal management system 100. In the present disclosure, the terminal device 2 is allowed to be a computer, smart phone, or tablet computer, providing an operation access for a carrier, a manager, or a worker.

The cargo terminal management system 100 comprises a carrier module 10, a management module 20, and an onsite module 30.

The carrier module 10 provides access to registration of a reservation information 11. The reservation information 11 is displayed on the terminal device 2. The reservation information 11 includes a reserved date, time, location, license plate, operation type, carrier, contact person, and contact information. The carrier module 10 generates a reservation certificate based on the reservation information 11. The reservation certificate is allowed to be in a form of a serial number, barcode, or QR code.

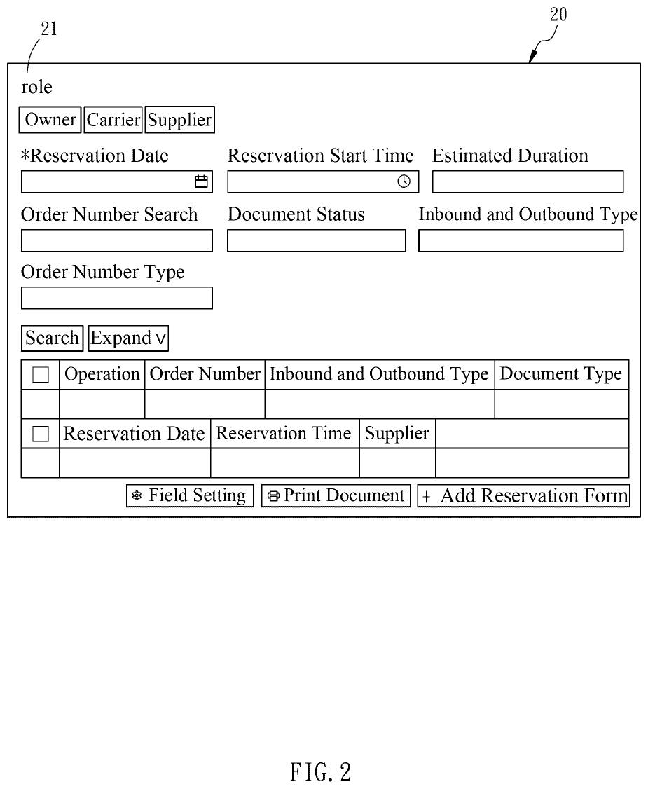

The management module 20 is coupled with the carrier module 10. Referring to FIG. 1 and FIG. 2, the management module 20 comprises a management information 21 corresponding to the reservation information 11. The management information 21 comprises but is not limited to the content in the reservation information 11. The management information 21 further comprises a reservation order number, related order number, document type, and dock status. The management information 21 is displayed on the terminal device 2 for the manager to monitor.

In the present disclosure, the management module 20 is also used to set the reservation information 11, such as the maximum reservable time period, the maximum reservable days, the definition of lateness, and the definition of no-show.

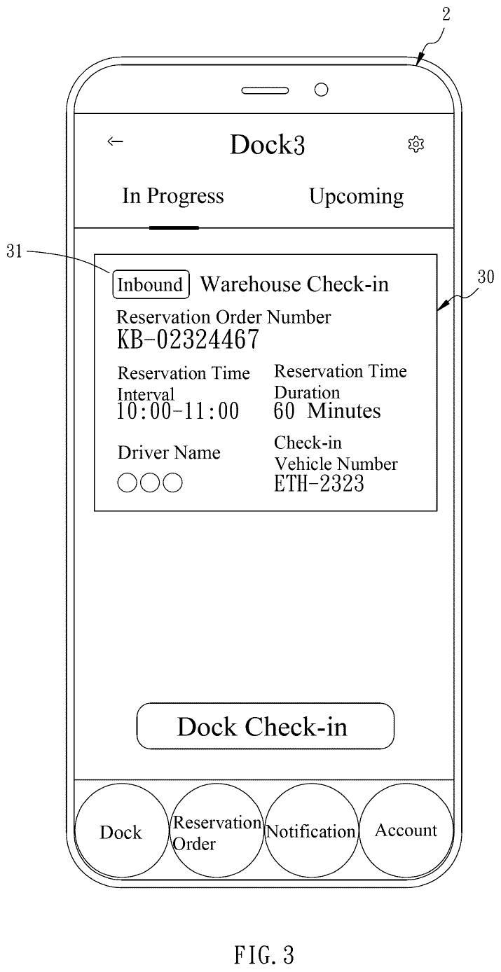

The onsite module 30 is coupled with the carrier module 10 and the management module 20. When the reservation certificate is input into the onsite module 30, the onsite module 30 generates a check-in information 31. Referring to FIG. 3, the check-in information 31 is displayed on the terminal device 2, which is allowed to be a work type, reservation order number, reservation time interval, reservation time duration, driver name, and check-in vehicle number, allowing the worker to monitor the process. The onsite module 30 transmits the check-in information 31 to the management module 20. Accordingly, the present disclosure is used by the manager and the worker for promptly understanding the dock conditions, and also preventing reservation contentions with carriers.

The cargo terminal management system 100 further comprises a smart monitoring module 40. The smart monitoring module 40 comprises a camera, which is disposed in a warehouse environment 3.

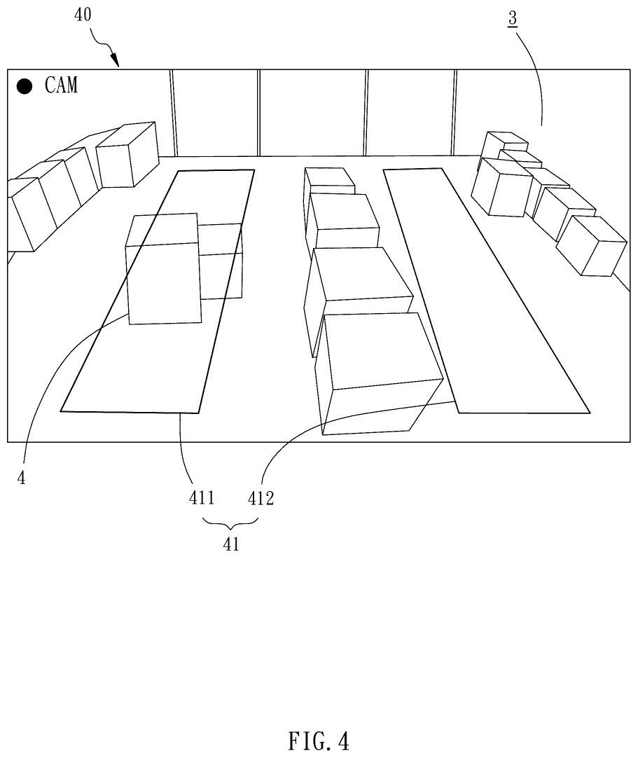

The smart monitoring module 40 is coupled with the management module 20 and the onsite module 30. Referring to FIG. 4, the smart monitoring module 40 captures an image of the warehouse environment 3 to obtain a warehouse image information 41. The warehouse image information 41 displays a cargo 4. The smart monitoring module 40 carries out an identification operation according to the warehouse image information 41 and generates an occupied status information 411 and an available status information 412, allowing the manager to understand the usage conditions of the warehouse. Therein, the occupied status information 411 and the available status information 412 are allowed to be presented separately or in combination.

Referring to FIG. 4, when the cargo 4 is placed in a storage area, the smart monitoring module 40 generates a red frame area on the warehouse image information 41; in other words, the smart monitoring module 40 generates the occupied status information 411. When there is no cargo 4 placed in the storage area, the smart monitoring module 40 generates a green frame area on the warehouse image information 41; in other words, the smart monitoring module 40 generates the available status information 412.

The smart monitoring module 40 comprises a vacancy notification unit 42. The vacancy notification unit 42 periodically generates an assignment awaiting information based on the available status information 412, and the assignment awaiting information is transmitted to the management module 20 and the onsite module 30, allowing the manager and the worker to understand the vacancy conditions of the warehouse environment 3.

The present disclosure does not exclude the combination with other broadcasting modules and notification units, providing information such as warehouse release, warehouse overuse, dock suspension, carrier lateness, carrier no-show cancellation, same-day reservation cancellation of carrier, and pending dock contact, so as to enhance the technical features of the present disclosure.

In an embodiment of the present disclosure, the management module 20 comprises an assignment unit 22. When the management module 20 receives the check-in information 31, the assignment unit 22 provides a dock assignment information according to the available status information 412 and transmits the dock assignment information to the carrier module 10. The carrier delivers the cargo 4 to the assigned dock according to the dock assignment information.

The management module 20 comprises an update unit 23. When the carrier module 10 confirms the selection of the dock assignment information, the update unit 23 accordingly updates the reservation information 11. For example, when the driver of the carrier completes the check-in process, the update unit 23 updates the reservation status of the dock, preventing the selected dock from being re-assigned to another carrier.

The reservation information 11 comprises an open reservation information and a closed reservation information. The open reservation information is used for non-designated user to make reservations for non-designated docks. The closed reservation information is only used for designated user to make reservations for designated docks. The management module 20 comprises an authorization unit 24. The authorization unit 24 is configured to set the reservation information 11 as either the open reservation information or the closed reservation information. Furthermore, the authorization unit 24 has a field interface for the manager to set up the configuration.

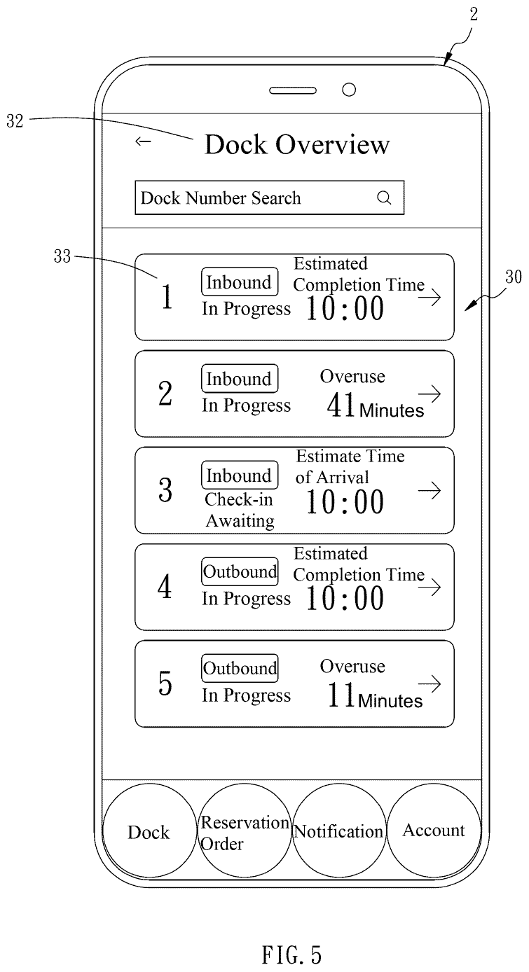

Referring to FIG. 5, the onsite module 30 comprises an operation overview unit 32. The operation overview unit 32 generates an operation progress information 33 according to the reservation information 11 and the check-in information 31, wherein the operation progress information 33 is allowed to be a work type, operation status, estimated completion time, and overuse, allowing the worker to track the operation progress.

In an embodiment of the present disclosure, the management module 20 comprise an assignment unit 22. The assignment unit 22 provides access to adding the dock assignment information, allowing the manager to timely distribute docks. The operation overview unit 32 generates the operation progress information 33 according to the dock assignment information.

The management module 20 comprises a reservation unit 25. The reservation unit 25 provides access to adding the reservation information 11, allowing the manager to assist the carrier in reserving a dock. The operation overview unit 32 generates the operation progress information 33 according to the newly added reservation information 11.

The management module 20 comprises a vendor management unit 26. The vendor management unit 26 provides access to registration of a vendor information, allowing the manager to manage the vendor partner. The vendor information includes the vendor name, unified number, collaboration type, and collaboration status.

With the foregoing configuration, advantages of the present disclosure will be illustrated below.

The operational efficiency is improved. The present disclosure uses various modules for reservation operations, not only simplifying the reservation process, but also achieving an efficient resources allocation, such as docks, personnel, and equipment, thereby enhancing operational efficiency and reducing workload of staff. Also, the present disclosure reduces the waiting time of the driver, preventing congestion of trucks caused by time waste of waiting.

The error rate is lowered. With a timely management, the present disclosure efficiently allows a quick understanding of docks'related information, thereby preventing information gaps between different units and reducing occurrence of errors.

The present disclosure intelligently monitors dock conditions. By generating the occupied status information 411 and the available status information 412 through the smart monitoring module 40, the present disclosure enables the manager to understand the usage status of the warehouse, thereby improving the management efficiency.

The operational safety is improved. The present disclosure helps reduce the movement of personnel at the dock, so as to achieve a safer working environment and further protect the safety of employees.

The aforementioned technical features does not preclude the existence of other technical features. Any technical features derivable from the specification, claims, or drawings, based on the common knowledge of those skilled in the field of the disclosure are also included within the scope of the technical features of the present disclosure.

Although particular embodiments of the disclosure have been described in detail for purposes of illustration, various modifications and enhancements may be made without departing from the scope of the disclosure. Accordingly, the disclosure is not to be limited except as by the appended claims.

What is claimed is:

1. A cargo terminal management system disposed on a server coupled with a terminal device, the terminal device running the cargo terminal management system, the cargo terminal management system comprising:
a carrier module providing access to registration of a reservation information, the carrier module configured to generate a reservation certificate based on the reservation information;
a management module coupled with the carrier module, the management module having a management information corresponding to the reservation information, the management information being displayed on the terminal device; and
an onsite module coupled with the carrier module and the management module; when the reservation certificate is input into the onsite module, the onsite module generates a check-in information displayed on the terminal device, and the onsite module transmits the check-in information to the management module.

2. The cargo terminal management system of claim 1, further comprising a smart monitoring module, wherein the smart monitoring module is coupled with the management module and the onsite module; the smart monitoring module is configured to capture an image of a warehouse environment to obtain a warehouse image information; the smart monitoring module carries out an identification operation according to the warehouse image information to generate an occupied status information and an available status information.

3. The cargo terminal management system of claim 2, wherein the smart monitoring module comprises a vacancy notification unit; the vacancy notification unit periodically generates an assignment awaiting information based on the available status information and transmits the assignment awaiting information to the management module and the onsite module.

4. The cargo terminal management system of claim 3, wherein the management module comprises an assignment unit; when the management module receives the check-in information, the assignment unit provides a dock assignment information according to the available status information and transmits the dock assignment information to the carrier module.

5. The cargo terminal management system of claim 4, wherein the management module comprises an update unit; when the carrier module confirms selection of the dock assignment information, the update unit updates the reservation information.

6. The cargo terminal management system of claim 4, wherein the reservation information includes an open reservation information and a closed reservation information; the management module comprises an authorization unit; the authorization unit is configured to set the reservation information as the open reservation information or the closed reservation information.

7. The cargo terminal management system of claim 3, wherein the onsite module comprises an operation overview unit; the operation overview unit generates an operation progress information according to the reservation information and the check-in information.

8. The cargo terminal management system of claim 7, wherein the management module comprises an assignment unit; the assignment unit provides access to adding a dock assignment information, and the operation overview unit generates the operation progress information according to the dock assignment information.

9. The cargo terminal management system of claim 8, wherein the management module comprises a reservation unit provides access to adding the reservation information, and the operation overview unit generates the operation progress information according to the added reservation information.

10. The cargo terminal management system of claim 9, wherein the management module comprises a vendor management unit, and the vendor management unit provides access to registration of a vendor information.
